(19) United States
(12) Patent Application Publication
(10) Pub. No.: US 2013/0261511 A1
(43) Pub. Date: Oct. 3, 2013

(54) THERAPY AND MOBILITY ASSISTANCE SYSTEM

(71) Applicants: Jonathan A. SMITH, Waterside New Brunswick (CA); Edith Merle ARNOLD, San Francisco, CA (US); Kern BHUGRA, San Jose, CA (US); Robert W. HORST, San Jose, CA (US); Richard R. MARCUS, Mountain View, CA (US)

(72) Inventors: Jonathan A. SMITH, Waterside New Brunswick (CA); Edith Merle ARNOLD, San Francisco, CA (US); Kern BHUGRA, San Jose, CA (US); Robert W. HORST, San Jose, CA (US); Richard R. MARCUS, Mountain View, CA (US)

(21) Appl. No.: 13/907,490

(22) Filed: May 31, 2013

Related U.S. Application Data
(63) Continuation of application No. 12/471,299, filed on May 22, 2009.
(60) Provisional application No. 61/151,114, filed on Feb. 9, 2009.

(51) Int. Cl. A61H 1/00

(52) U.S. Cl. CPC A61H 1/00
USPC 601/5

(57) ABSTRACT

A therapy and mobility assistance system used by a patient that includes a leg device worn on the leg of the patient that provides assistance and/or resistance to enhance the mobility of the leg of the patient, a therapy shuttle that facilitates therapeutic extension and flexion of at least one of the joints of the leg of the patient, and an appendage fastener that selectively couples the therapy shuttle and the leg device. The therapy and mobility assistance system may additionally include a guide track that constrains motion of the therapy shuttle along a path.

### CROSS REFERENCE TO RELATED APPLICATIONS

This application is a continuation of U.S. patent application Ser. No. 12/471,299, filed May 22, 2009, titled “THERAPY AND MOBILITY ASSISTANCE SYSTEM,” Publication No. US-2010-0204620-A1, which claims the benefit of U.S. Provisional Patent Application No. 61/151,114, filed Feb. 2, 2009, titled “THERAPY AND MOBILITY ASSISTANCE SYSTEM,” each of which is herein incorporated by reference in its entirety.

### INCORPORATION BY REFERENCE

All publications and patent applications mentioned in this specification are herein incorporated by reference to the same extent as if each individual publication or patent application was specifically and individually indicated to be incorporated by reference.

### FIELD

This invention relates generally to the active orthosis field, and more specifically to a new and useful combined therapy and mobility assistance system in the active orthosis field.

### BACKGROUND

A common physical therapy treatment for patients recovering from reconstructive joint surgeries is continuous passive motion (CPM) therapy, which aids recovery by reducing joint stiffness, increasing joint range of motion, and increasing circulation. CPM therapy uses external forces, such as that from a powered, motorized leg device carrying the leg of the patient, to passively move the reconstructed joint through a controlled range of motion throughout joint flexion and extension.

For those recovering from knee surgeries such as total knee replacement, CPM therapy may be performed by a leg device worn by the patient, with the patient's leg in a nonvertical position to reduce weight loads directly on the knee. For a patient in such a position, CPM therapy causes the foot of the patient to tend to move in a path that is longitudinal to the patient. However, guidance of foot motion and prevention of internal and external rotation of the leg (rotation about an axis longitudinal to the patient) during CPM therapy is necessary for proper rehabilitation and to avoid inflicting pain and injury on the patient.

Current machines that provide CPM therapy for the leg, which require the patient to strap their leg into the device, are for sedentary use only. These existing CPM machines not only restrict mobility of the patient for long periods of time, but also have little other function besides providing CPM therapy, which is not cost-effective. Other therapy devices also have the same drawbacks of dedicated sedentary use, such as those that provide robotic therapy, in which the device interacts with and improves the patient's existing physical abilities. Thus, there is a need in the physical therapy field to create a new and useful system to provide CPM or robotic therapy, to support and guide the foot and leg of a patient undergoing CPM or robotic therapy, and provide mobility assistance to the patient during recovery. This invention provides such a new and useful therapy and mobility assistance system.

### BRIEF DESCRIPTION OF THE DRAWINGS

FIGS. 1a and 1b are schematics of the first preferred embodiment of the invention, in extended and flexed leg positions, respectively.

FIG. 2 is a schematic of a variation of the guide track of the first preferred embodiment.

FIG. 3 is a cross-sectional view schematic of the therapy shuttle and guide track of the first preferred embodiment.

FIGS. 4a and 4b are a side view schematic and a cross-sectional view schematic, respectively, of a variation of the therapy shuttle and guide track of the first preferred embodiment

FIGS. 5a and 5b are schematics of another variation of the shuttle of the first preferred embodiment, in extended and flexed leg positions, respectively.

FIGS. 6a and 6b are schematics of the second preferred embodiment, in extended and flexed leg positions, respectively.

FIGS. 7a and 7b are schematics of a variation of the second preferred embodiment, in extended and flexed leg positions, respectively.

FIGS. 8a and 8b are perspective views of a first variation of the appendage fastener in the disengaged position and engaged position, respectively.

FIG. 9 is a perspective view of an example of the second variation of the appendage fastener in the disengaged position.

FIG. 10 is a perspective view of another example of the second variation of the appendage fastener in the engaged position.

### DETAILED DESCRIPTION

The following description of the preferred embodiments of the invention is not intended to limit the invention to these preferred embodiments, but rather to enable any person skilled in the art to make and use this invention.

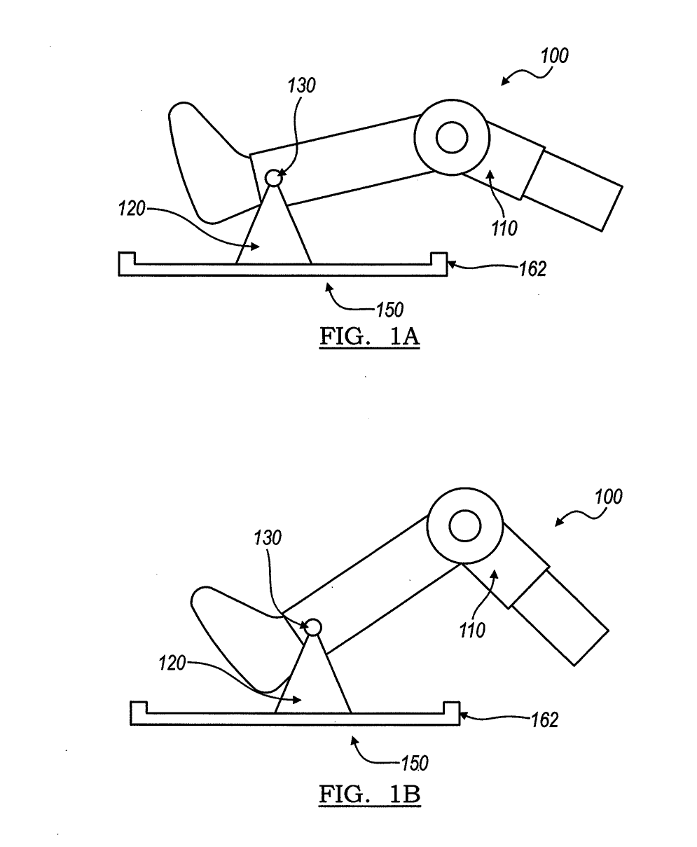

As shown in FIGS. 1a and 1b, the therapy and mobility assistance system 100 of the first preferred embodiment includes a leg device 110 worn on the leg of a patient that provides at least one of assistance and resistance to enhance the mobility of the leg of the patient, a therapy shuttle 120 that facilitates therapeutic extension and flexion of at least one of the joints of the leg of the patient, and an appendage fastener 130 that selectively couples the therapy shuttle and the leg device. The first preferred embodiment may also include a guide track 150 that constrains motion of the therapy shuttle along a path.

The therapy and mobility assistance system 100 has been specifically designed to provide CPM therapy, to support and guide the foot and leg of a patient undergoing CPM therapy, and provide mobility assistance to the patient during recovery. The therapy and mobility assistance system may be particularly useful for applications that require powered flexion and extension of the knee joint: for example, providing powered assistance to patients with weakened muscles; accommodating strength training exercises; and facilitating robotic therapy, in which a robotic device interacts with and improves the patient's existing physical abilities. The therapy and mobility assistance system 100 may, however, be used in any suitable situation for any suitable reason.

The leg device 110 is worn by a patient on his leg and provides active muscle assistance and is operable in multiple modes to enhance mobility, build muscle strength, and prevent injury. The leg device 110 is preferably the powered leg device described in U.S. Pat. No. 6,966,882 entitled “Active muscle assistance device and method”, which is incorporated in its entirety by this reference, but may alternatively be any orthosis, prosthesis, or any suitable device used in therapy, training, or mobility assistance. The powered leg device is preferably actuated by the actuator system described in U.S. patent application Ser. No. 12/191,837 entitled “Actuator System With a Multi-Motor Assembly For Extending and Flexing a Joint”, which is incorporated in its entirety by this reference, but may alternatively be actuated by any suitable device or method. The powered leg device 110 is preferably operable in at least both 1) a therapy mode in which the powered leg device no provides CPM therapy or another suitable kind of physical therapy that provides therapeutic extension and flexion to one or more joints of the leg, and 2) a mobility assistance mode in which the powered leg device no supplements muscle strength by providing assistance and resistance to aid the mobility of the patient during daily activities such as walking, sitting down, and ascending and descending stairs.

The therapy shuttle 120 of the first preferred embodiment, which is placed on a surface on or near the ground, functions to support the weight of and carry the leg and/or foot of the patient in a path throughout therapeutic motions of the leg such as extension and flexion. The therapy shuttle 120 preferably moves in a flat and straight path, and allows the leg of the patient to rotate about a horizontal axis. For example, a patient who is reclined on a flat surface and undergoing leg CPM therapy may experience their foot translating in a linear path along the length of their body and their leg rotating about a horizontal axis throughout the range of motion of their knee. The therapy shuttle 120 preferably has a mechanism that allows the leg of the patient to rotate relative to the therapy shuttle 120 about a horizontal axis with low friction, such as with a radial bearing, a smooth bearing surface, or any other suitable method of rotation.

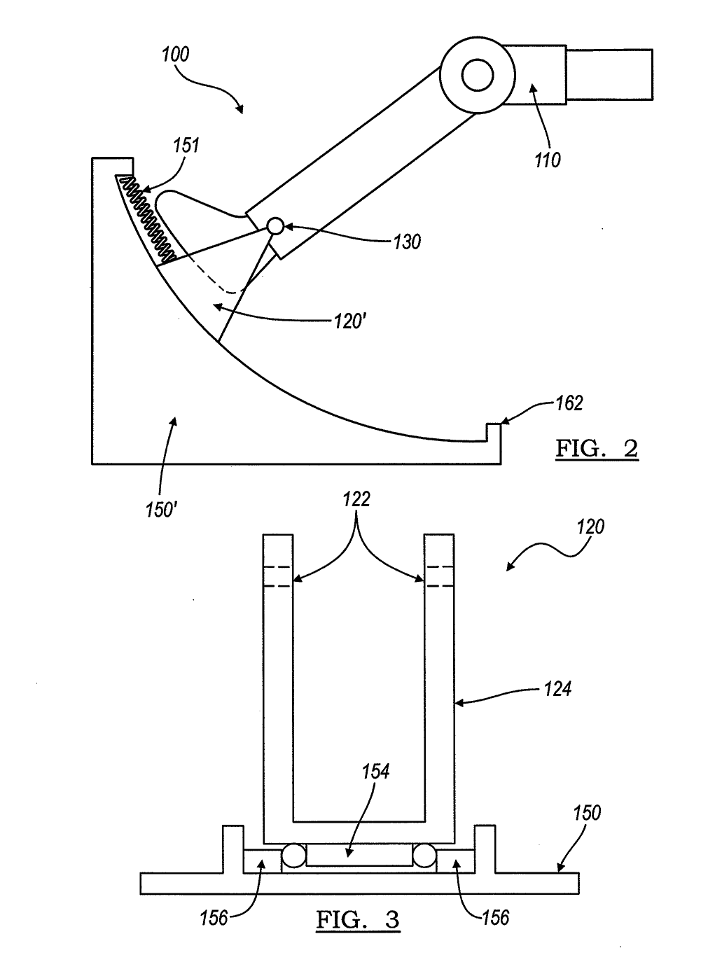

In other variations of the therapy shuttle 120, the path of the therapy shuttle 120 may depend on the orientation of the patient. For example, as shown in FIG. 2, a second variation of the therapy shuttle 120′ carries the leg and/or foot of the patient on an incline or sweeps along a curved ramp, to accommodate a patient who is sitting in a high chair and undergoing leg CPM therapy and may experience their foot translating on an incline or sweeping a curved path as their knee flexes and extends. Similar to the first variation of the therapy shuttle 120, the second variation of the therapy shuttle 120′ preferably has a mechanism to allow the leg of the patient to pivot relative to the therapy shuttle 120′ about a lateral axis.

As shown in FIGS. 1a and 1b, the appendage fastener 130 of the first preferred embodiment attaches the powered leg device 110 to the therapy shuttle 120. The appendage fastener 130 preferably is movable between an engaged position and a disengaged position, to allow the powered leg device 110 to easily and quickly detach from the therapy shuttle 120. In the engaged position, the powered leg device 110 is attached to the therapy shuttle 120 so that as the patient wearing the powered leg device 110 undergoes physical therapy with the powered leg device 110 in therapy mode, and the therapy shuttle 120 carries their leg. In the disengaged position, the powered leg device 110 is detached from the therapy shuttle 120. The ability to easily and quickly disengage the powered leg device 110 allows frequent interruptions which may be desired, for example, to facilitate greater flexibility and variety in therapy methods during a therapy session, or to allow the patient to take a break. Furthermore, when the patient is detached from the therapy shuttle 120, the powered leg device 110 is able to operate in additional modes such as providing mobility assistance to the patient. These additional modes may be useful if, for example, the patient needs to go to the restroom during a therapy session, or if the patient would like assistance during walking and other daily activities without doffing and donning multiple devices.

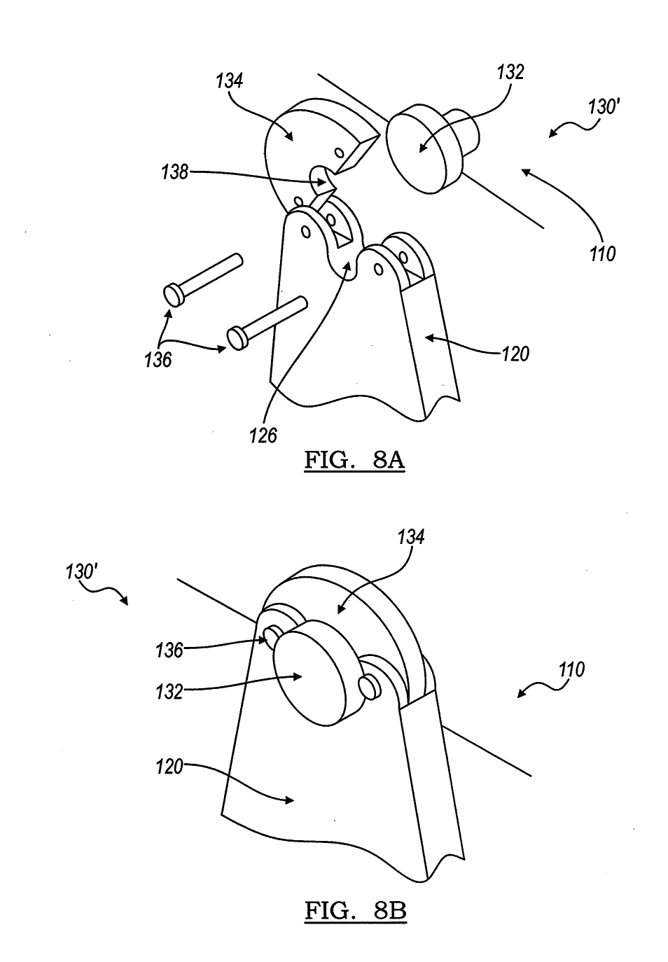

The appendage fastener 130′ of a first variation, as shown in FIGS. 8a and 8b, locks onto a knob 132 on each side of the leg or other suitable external feature of the powered leg device no. This variation of the appendage fastener 130′ includes a clamp 134 that locks the knob 132 onto the therapy shuttle 120, a hinge that allows the clamp 134 to swing between a disengaged position (FIG. 8a) and an engaged position (FIG. 8b), and pins 136 to secure the clamp 134 in the engaged position. The appendage fastener 130′ may partially or wholly incorporate the mechanism of the therapy shuttle 120 that allows the leg of the patient to rotate relative to the therapy shuttle 120, such as by having a smooth bearing surface 138 and/or 126.

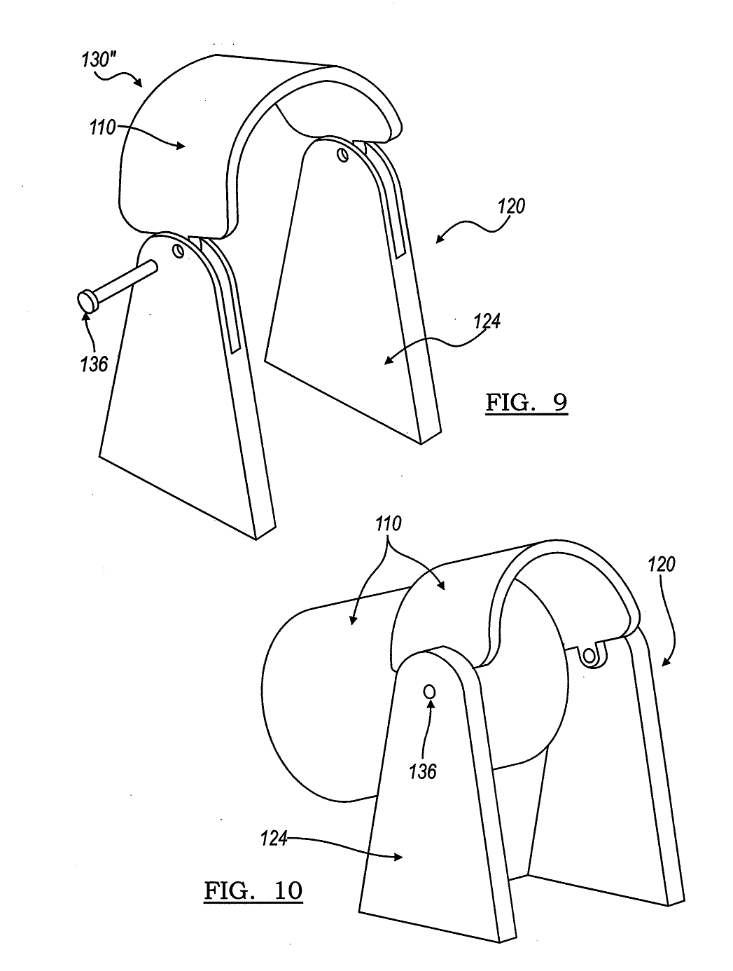

The appendage fastener 130″ of a second variation, as shown in FIGS. 9 and 10, locks into a hole on each side of the powered leg device no or other suitable openings of the powered leg device no. This variation of the appendage fastener 130″ includes a pin 136 that locks the hole of the powered leg device 110 into alignment with holes in the therapy shuttle 120. As shown in FIG. 9, the appendage fastener pin 136 aligns a feature of the powered leg device 110 between forks of a side wall of the therapy shuttle 120. As shown in FIG. 10, the appendage fastener pin 136 aligns a feature of the powered leg device 110 with holes of non-forked wall of the therapy shuttle 120. Like the appendage fastener 130′ of the first variation, the appendage fastener 130″ of the second variation may partially or wholly incorporate the mechanism of the therapy shuttle 120 that allows the leg of the patient to rotate relative to the therapy shuttle 120.

In additional variations of the appendage fastener 130, the appendage fastener 130 may attach the powered leg device 110 to the therapy shuttle 120 by allowing the patient to insert their leg or foot into an enclosure, such as a setup of straps including buckles, buttons, snaps, hook and loop, or any other suitable fastener. The enclosure may alternatively be a full leg or foot enclosure such as a shoe, sock, cradle, sling, and/or any other suitable means of securing the foot and/or leg.

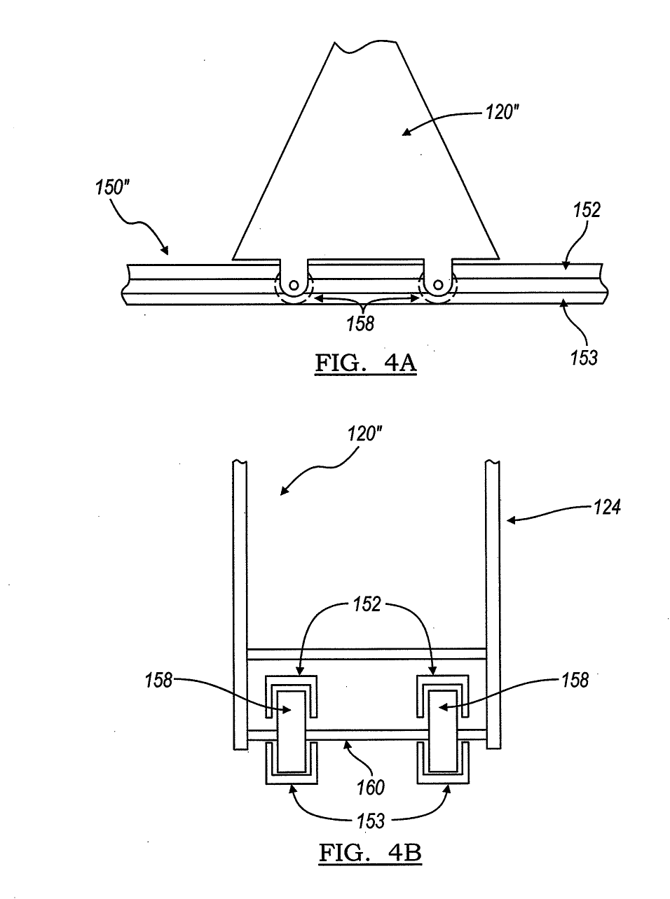

As shown in FIGS. 1a and 1b, the therapy and mobility assistance system 100 of the first preferred embodiment also includes a guide track 150 that guides the therapy shuttle 120 to move in a particular path. The guide track 150 may vary with different variations of the therapy shuttle 120. Paired with the preferred variation of the therapy shuttle 120, the guide track 150 is preferably generally flat and straight. The guide track 150 preferably reduces friction of motion of the therapy shuttle 120, with a mechanism such as a slider bearing (shown in FIG. 3), whose rails 156 fasten to the guide track 150 and whose carriage 154 fastens to the therapy shuttle 120 such that the therapy shuttle 120 travels within the guide track 150 by each stroke of the slider bearing. As shown in FIGS. 4A and 4B, the guide track 150 may alternatively consist of a track with internal grooves such as that created by a set of upper rails 152 and lower rails 153, wheels 158 to move within the internal grooves, and an axle 160 or other means to attach the wheels 158 to the therapy shuttle 120 such that the therapy shuttle 120 can travel on the wheels 158 within the guide track 150. The guide track 150 also preferably includes a physical stop on each end that determines the forward extreme and rear extreme of the range of motion of the therapy shuttle 120. The physical stop may be an upturned lip 162 on each end of the guide track 150, the stroke length limit of a slider bearing in the guide track 150, and/or any other suitable method of limiting travel of the therapy shuttle 120 within the guide track 150.

Additional variations of the guide track 150 depend on the path in which the therapy shuttle 120 moves. For example, as shown in FIG. 2, the guide track 150′ may be curved to accommodate the path of the therapy shuttle 120′ that is required to shuttle the leg of the patient through a sweeping curve when a patient undergoes therapy in a sitting position. For variations of the guide track that accommodate therapy shuttle paths that act against gravity, an assist mechanism such as a tension spring 151 or other means for creating variable resistance to the therapy shuttle motion is preferably included in the guide track 150′ to help counteract gravity and equalize the amount of force required to move the leg throughout flexion and extension. An additional feature of the therapy and mobility assistance system 100 is a means for reducing internal and external rotation of the leg of the patient. The system may reduce internal and external rotation of the leg by: 1) having the therapy shuttle 120 include side walls 124 (shown in FIG. 3) or padding located on each side of the therapy shuttle 120 to reduce lateral motion of the leg of the patient within the therapy shuttle 120; 2) having the therapy shuttle 120 substantially wider than the powered leg device 110; 3) having a locking means or other physical restraint within the powered leg device 110; and/or 4) any other suitable mechanism of reducing relative lateral motion between the therapy shuttle 120 and guide track 150.

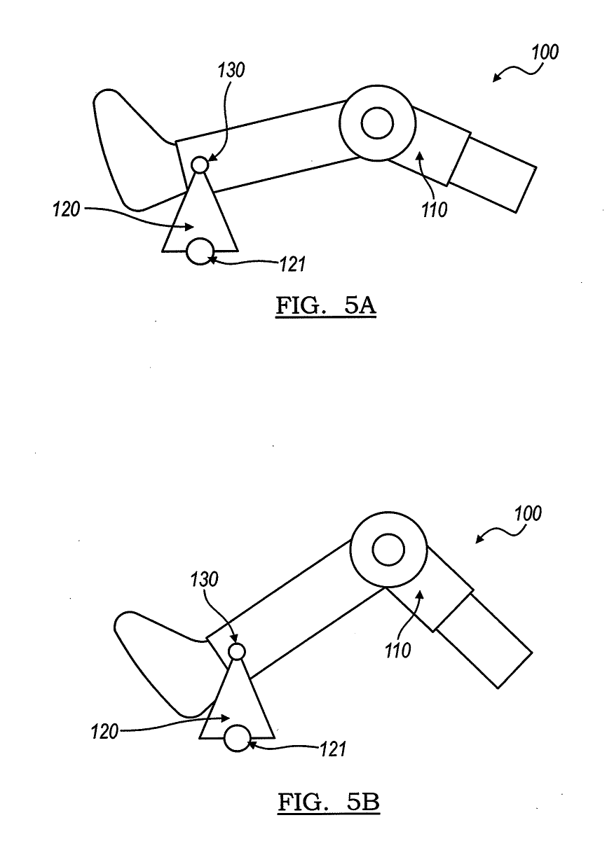

In an alternative of the first preferred embodiment, as shown in FIG. 5, the guide track 150 may be omitted to allow the therapy shuttle 120 to move directly on the surface to accommodate the extension and flexion of the leg. In this alternative, the therapy shuttle 120 may have a smooth sliding surface to move like a sled on the surface, one or more wheels 121 to move like a skate on the surface, or any suitable mechanism of moving directly on the surface.

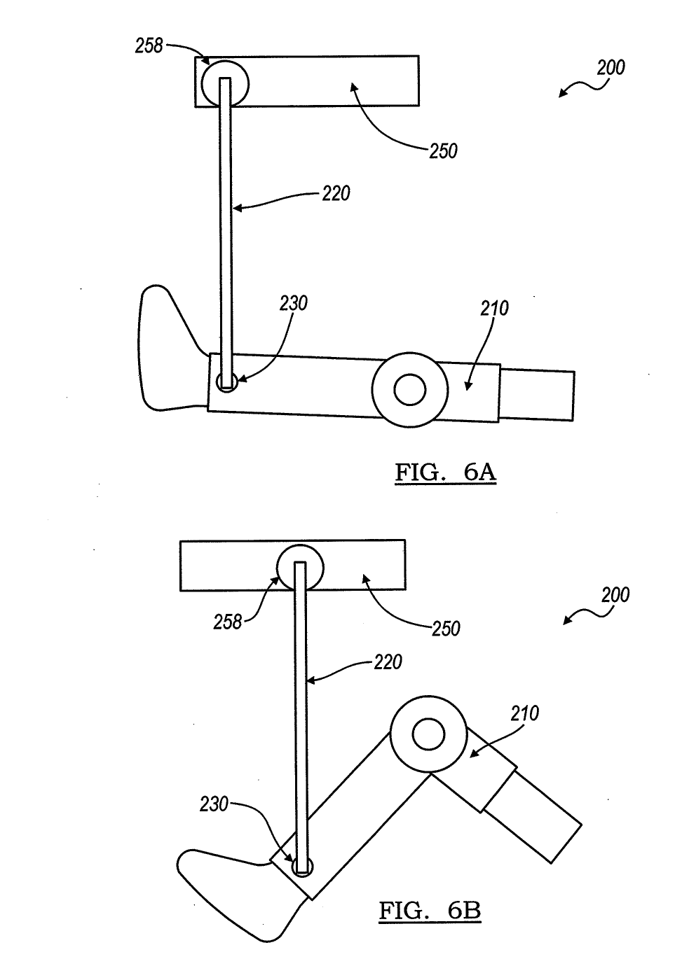

As shown in FIGS. 6a and 6b, like the system 100 of the first preferred embodiment, the therapy and mobility assistance system 200 of the second preferred embodiment includes a leg device 210 worn on the leg of a patient that provides at least one of assistance and resistance to enhance the mobility of the leg of the patient, a therapy shuttle 220 that facilitates therapeutic extension and flexion of at least one of the joints of the leg of the patient, an appendage fastener 230 that selectively couples the therapy shuttle and the leg device, and an optional guide track 250 that constrains motion of the therapy shuttle along a path. The leg device 210, the therapy shuttle 220, the appendage fastener 230, and the guide track 250 of the second preferred embodiment 200 are preferably identical to that of the first preferred embodiment 100, with the following exceptions.

The therapy shuttle 220 of the second preferred embodiment carries and/or suspends the leg and/or foot of the patient in a path that is substantially longitudinal to the patient. The therapy shuttle 220 preferably includes rollers 258 that translate along the guide rail 250 while the fastener 230, attached near the foot, translates below the guide rail 250. The therapy shuttle 220 of the second preferred embodiment easily accommodates a patient who is lying on their back or seated and undergoing therapy and may experience their lower leg translating horizontally as their knee flexes and extends. As an example, when robotic or CPM therapy is being administered in a supine position in a bed, the distance between the guide rail 250 and the fastener 230 is preferably set to allow the foot to travel unimpeded just above the surface of a bed. Similarly in another example, when the therapy is being administered in a seated position, the distance between the guide rail 250 and the fastener 230 is preferably set to allow the foot to travel unimpeded just above the surface of the floor. Similar to the therapy shuttle 120 of the first preferred embodiment, the therapy shuttle 220 of the second preferred embodiment preferably has a mechanism to allow the leg of the patient to pivot relative to the therapy shuttle 220 about a lateral axis. Like the therapy shuttle 120 of the first preferred embodiment, additional variations of the therapy shuttle 220 of the second preferred embodiment may depend on the physical and spatial requirements of the orientation of the patient during therapy.

Similar to the guide track 150 of the first preferred embodiment, the guide track 250 of the second preferred embodiment guides the therapy shuttle 220 to move in a particular path, and may vary with different variations of the therapy shuttle 220.

As shown in FIGS. 6a and 6b, the guide track 250 is preferably mounted on the ceiling or another overhead surface, but may be any other suitable surface such as a wall. The overhead guide track may also be supported from below using supports connected to a bed, chair or floor-mounted bracket.

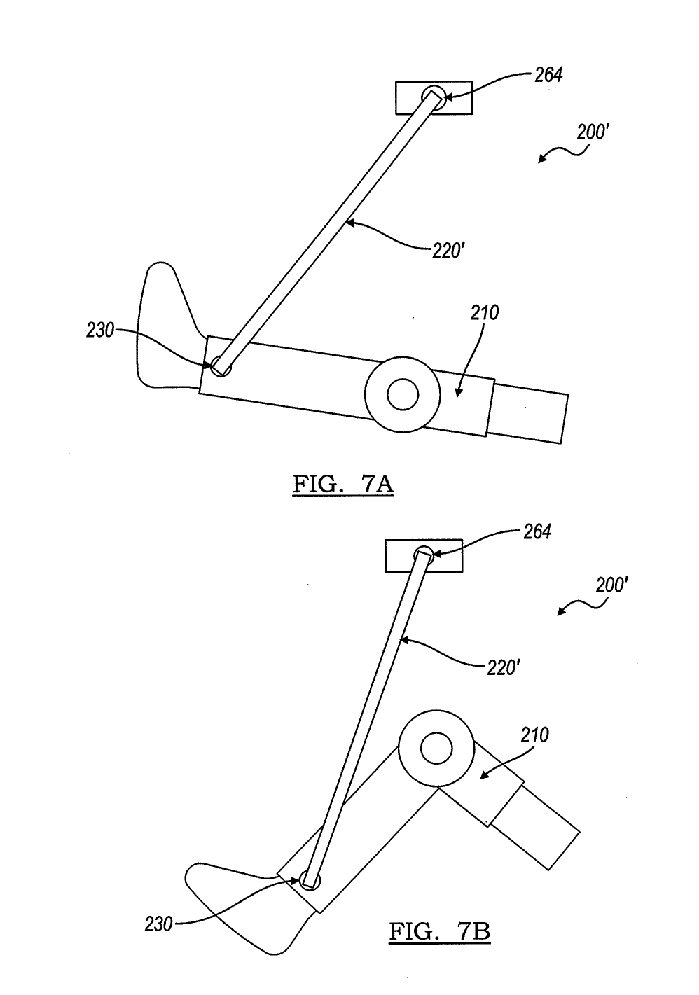

As shown in FIGS. 7a and 7b, a variation of the second preferred embodiment 200′ omits the track and instead has a single pivot point 264 above the patient. The therapy shuttle 220′ connects the pivot point to the appendage fastener 230 and guides the foot along a curved path around the pivot point. As the knee extends during robotic or CPM therapy, the foot elevates slightly above the bed or floor following this curved path. Similar to the first version of the second preferred embodiment, this variation of the second preferred embodiment may be used to administer robotic or CPM therapy to a patient who is lying on their back or in a seated position. In this variation of the second preferred embodiment, the therapy shuttle 220′ may be a rigid structure such as a bar, or a flexible strap or other adjustable structure that is adjustable to comfortably accommodate a range of patient sizes and/or desired leg elevations. Like the therapy shuttle 120 of the first preferred embodiment, additional variations of the therapy shuttle 220′ of the variation of the second preferred embodiment may depend on the physical and spatial requirements of the orientation of the patient during therapy.

As a person skilled in the art of active orthoses will recognize from the previous detailed description and from the figures and claims, modifications and changes can be made to the preferred embodiments of the invention without departing from the scope of this invention defined in the following claims.

What is claimed is:

1. A therapy and mobility assistance system used by a patient comprising:
a leg device worn on the leg of the patient operable in a mobility assistance mode when the patient is in an ambulatory state that provides at least one of assistance and resistance to enhance the mobility of the leg of the patient, and a therapy mode that facilitates therapeutic extension and flexion of at least one of the joints of the leg of the patient when the patient is undergoing a therapy;
a therapy shuttle that facilitates therapeutic extension and flexion of at least one of the joints of the leg of the patient; and
an appendage fastener that selectively couples the therapy shuttle and the leg device in an engaged position in which the leg device is attached to the therapy shuttle and a disengaged position in which the leg device is detached from the therapy shuttle.

2. The system of claim 1, wherein in the engaged position the appendage fastener allows pivotal movement between the therapy shuttle and leg device.

3. The system of claim 1, wherein the therapy shuttle reduces internal rotation and external rotation of the leg of the patient.

4. The system of claim 1, wherein the therapy shuttle is wider than the leg device.

5. The system of claim 1, wherein the therapy shuttle includes at least one side wall adjacent to the leg device.

6. The system of claim 1, wherein at least a portion of the therapy shuttle is adapted to be mounted above the patient.

7. The system of claim 1 the appendage fastener further comprising: a latch that locks onto the leg device when the appendage fastener is in the engaged position.

8. The system of claim 7 the leg device further comprising: a protrusion positioned to engage the latch.

9. The system of claim 7 the leg device further comprising: an opening positioned to engage the latch.

10. The system of claim 1, wherein when the appendage fastener is in the disengaged position, the leg device operates in the mobility assistance mode independent of the therapy shuttle.

11. The system of claim 1, wherein when the appendage fastener is in the engaged position and the leg device is operated in the therapy mode, the therapy shuttle moves to accommodate the therapeutic extension and flexion of at least one of the joints of the leg of the patient.

12. The system of claim 1, further comprising: a guide track that constrains motion of the therapy shuttle along a path.

13. The system of claim 12, wherein the guide track and the therapy shuttle cooperate to reduce friction during the therapeutic extension and flexion of at least one of the joints of the leg of the patient.

14. The system of claim 13, wherein the guide track includes a linear bearing.

15. The system of claim 12, wherein the guide track is adapted to be placed on a surface.

16. The system of claim 15, wherein the guide track is generally flat and parallel to the surface.

17. The system of claim 15, wherein the guide track is curved.

18. The system of claim 12, wherein the guide track is adapted to be mounted above the patient.

19. The system of claim 12, wherein the guide track limits the range of motion of the therapy shuttle.

20. The system of claim 1, wherein the leg device includes an actuator system that includes:
a drive shaft that provides rotational output;
a first motor subsystem having a first output shaft and a first transmission connecting the first output shaft to the drive shaft;
a second motor subsystem having a second output shaft and a second transmission coupling the second output shaft to the drive shaft; and
a coupling from the drive shaft to apply force to flex or extend the leg.

21. A therapy and mobility assistance system used by a patient, comprising:
a leg device worn on the leg of the patient that provides motion control of the leg of the patient in a mobility assistance mode and a therapy mode;
a therapy shuttle that facilitates therapeutic extension and flexion of at least one of the joints of the leg of the patient; and
an appendage fastener movable between an engaged position and a disengaged position, wherein the appendage fastener in the engaged position couples the therapy shuttle to the leg device enabling the therapy shuttle to move to accommodate the therapeutic extension and flexion of at least one of the joints of the leg of the patient; and wherein the appendage fastener in the disengaged position decouples the therapy shuttle from the leg device enabling the leg device to operate in the mobility assistance mode independent of the therapy shuttle.

22. The system of claim 21, further comprising a guide track that constrains motion of the therapy shuttle along a path.

23. The system of claim 21, wherein the leg device includes an actuator system that includes:
a drive shaft that provides rotational output;
a first motor subsystem having a first output shaft and a first transmission connecting the first output shaft to the drive shaft; and
a second motor subsystem having a second output shaft and a second transmission coupling the second output shaft to the drive shaft.

24. A method of providing therapy and mobility assistance to a patient, comprising the steps of:
fastening onto a leg of the patient a leg device that provides motion control of the leg of the patient in a mobility assistance mode and a therapy mode;
selectively coupling the leg device to a therapy shuttle;
performing therapeutic extension and flexion of at least one of the joints of the leg of the patient using the therapy shuttle with the leg device in a therapy mode;
uncoupling the leg device from the therapy shuttle; and
operating the leg device in a mobility assistance mode after the uncoupling step.
